(19) United States
(12) Patent Application Publication
(10) Pub. No.: US 2013/0175335 A1
(43) Pub. Date: Jul. 11, 2013

(54) USE OF BARCODE FOR PRODUCT INSTRUCTION

(71) Applicant: Christopher F. Roberts, South Glastonbury, CT (US)

(72) Inventor: Christopher F. Roberts, South Glastonbury, CT (US)

(73) Assignee: Core Temp, LLC, South Glastonbury, CT (US)

(21) Appl. No.: 13/543,072

(22) Filed: Jul. 6, 2012

Related U.S. Application Data
(60) Provisional application No. 61/505,021, filed on Jul. 6, 2011.

(51) Int. Cl. G06F 17/30

(52) U.S. Cl. CPC G06F 17/30823
USPC 235/375

(57) ABSTRACT

Systems and methods for using barcodes to provide product information to users with computing devices capable of scanning the barcodes. The product information may include one or more videos including instructional information, safety information, product features information, or other product information. In some embodiments, the barcodes are configured to provide links to entertainment videos, promotional videos, or advertising videos that may or may not be directly related to the products to which the barcodes are affixed.

### CROSS REFERENCE TO RELATED APPLICATION(S)

This application claims the benefit of U.S. Provisional Patent Application No. 61/505,021, filed Jul. 6, 2011.

### BACKGROUND OF THE INVENTION

1. Field of the Invention

The present invention is directed generally to systems and methods for providing information to consumers, and more specifically, to systems and methods for using barcodes to provide product or advertising information to a user of a mobile device capable of reading barcodes.

2. Description of the Related Art

Consumer products are often packaged and sold with various types of information accompanying the products. For example, some products include an owner's manual, in the form of a booklet, which may include information such as safety information, assembly instructions, normal usage instructions, maintenance and care instructions, and the like. Some products may also include packaging that includes similar information. As can be appreciated, the amount and type of information included with a product may be limited due the size of a product and its packaging. Further, the additional costs associated with shipping information such as booklets or videos with products may be undesirable.

### BRIEF DESCRIPTION OF THE SEVERAL VIEWS OF THE DRAWINGS

FIG. 1 is a block diagram of a system for using barcodes to provide product information in accordance with an embodiment of the present invention.

FIG. 2 is a block diagram illustrating the functional modules of various components of the system shown in FIG. 1.

FIG. 3 is a flow chart of a method for using barcodes to provide product information.

FIG. 4 is a depiction of a product having a barcode displayed thereon that encodes a link to a video that includes information related to the product.

FIG. 5 is a depiction of another product having a barcode displayed thereon that encodes a link to a video that provides entertainment and/or advertising content.

FIG. 6 depicts a diagram of a hardware environment and an operating environment in which one or more computing devices associated with the system of the present invention may be implemented.

### DETAILED DESCRIPTION OF THE INVENTION

Embodiments of the present invention are directed to systems and methods for using two dimensional (2D) barcodes (e.g., quick response (QR) barcodes, matrix barcodes, and the like) to provide product information to users with mobile devices capable of scanning the barcodes. In general, a barcode is an optical machine readable representation of data, which encodes data about the object to which it is attached. As an example, a QR barcode is a matrix barcode (or two-dimensional barcode) that is readable by QR barcode readers and many currently-available camera phones. A QR barcode consists of colored modules arranged in a square pattern on a white background. The information encoded in a QR barcode may be text, a uniform resource locator (URL), or other data. Although QR barcodes are discussed in the description below, it will be appreciated that other types of barcodes (or machine-readable representations of data) may be used as well.

In the embodiments of the present invention, the product information may include instructional information, safety information, product features information, or other product information. In some embodiments, the barcodes are configured to provide links to entertainment, promotional and/or advertising content that may or may not be directly related to the products to which the barcodes are affixed.

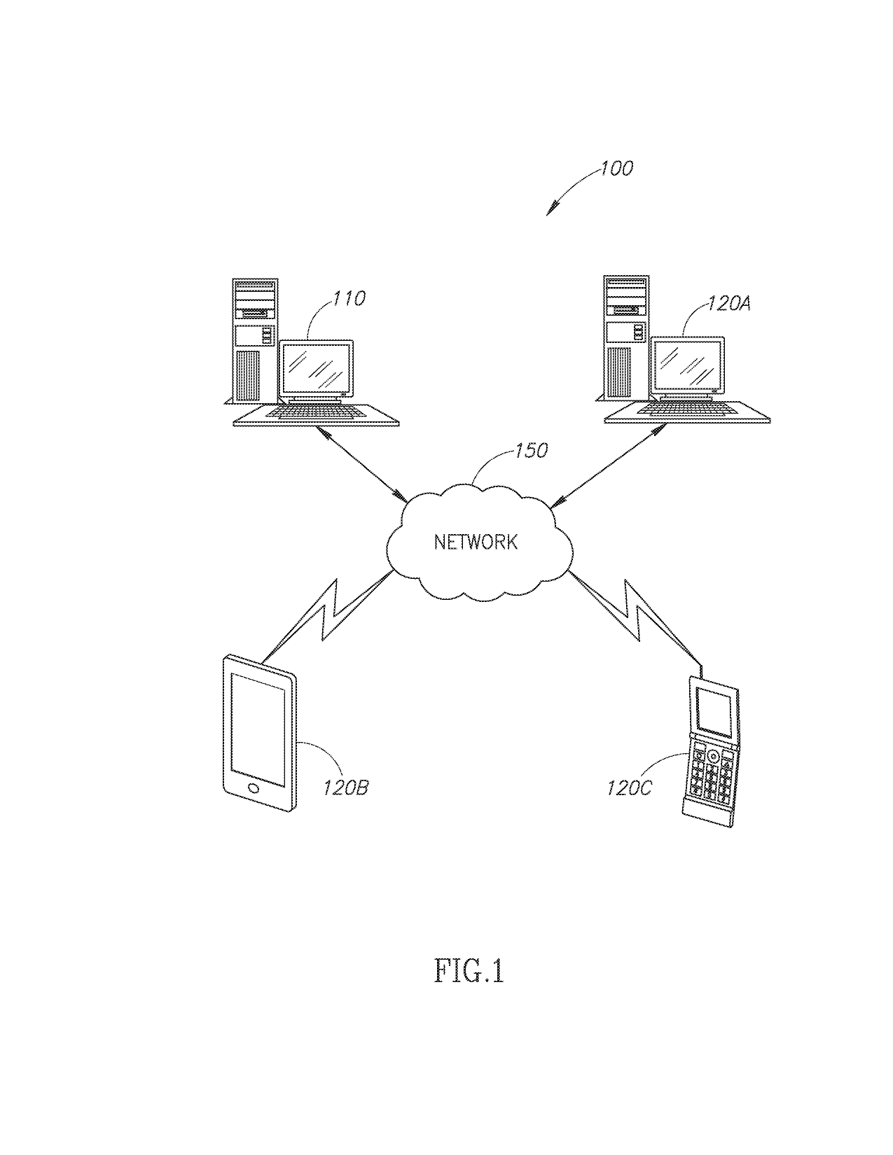

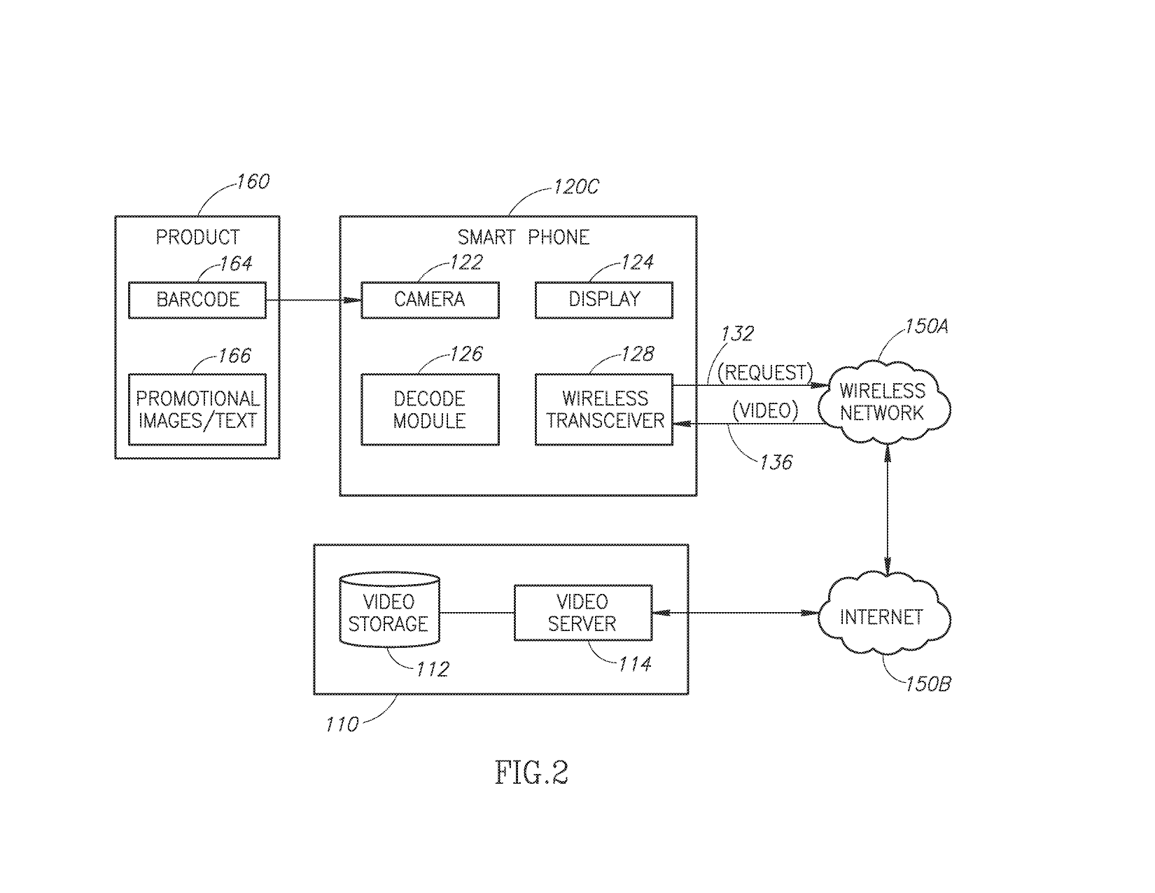

FIG. 1 is an illustration of a system 100 that may be used to provide the functionality of the present invention. The system 100 includes at least one server computing device 110 that may comprises, for example, a conventional web server or video server 114 and a video storage 112 (see FIG. 2). The system 100 also comprises at least one client computing device (e.g., client computing devices 120A-120C). The server computing device 110 is connected to the client computing devices 120A-120C by a network 150 (e.g., the Internet). The server computing device 110 and the client computing device 120C are shown in further detail in FIG. 2. As shown, the network 150 may comprise a wireless network 150A (e.g., a cellular network) and the Internet 150B, or any other combination of wired and/or wireless networks.

The server computing device 110 is configured to provide a website, a mobile application, one or more videos, and the like, to the client computing devices 120A-120C. As can be appreciated, in embodiments in which the server computing device 110 provides a website or a video, the server computing device 110 includes conventional components and related files operable to display a website or a video on the client computing devices 120A-120C. For example, the server computing device 110 may be operative to deliver a video providing information relating to a product to the client computing devices 120A-120C when one of the devices requests a uniform resource locator (URL) of a video using a web browser. This may be accomplished by retrieving the video from the video storage 112 and serving the video to one or more of the client computing devices 120A-120C using the video server 114.

While the system 100 is illustrated as including the single server computing device 110, those of ordinary skill in the art will appreciate that the system 100 may include any number of server computer devices that each perform the functions of the server computing device 110 or cooperate with one another to perform those functions. Further, while the server computing device 110 is illustrated as being connected to the three client computing devices 120A-120C, those of ordinary skill in the art will appreciate that the server computing device may be connected to any number of client computing devices and the server computing device is not limited to use with any particular number of client computing devices.

The client computing devices 120A-120C are each operated by a user of a product, such as a consumer or a sales associate. The client computing devices 120A-120C may each include a conventional web browser configured to display websites and videos provided on websites using a display of the client computing device. By way of non-limiting examples, in FIG. 1, the client computing device 120A is illustrated as a personal computer (e.g., a laptop, tablet personal computer, and the like), the client computing device 120B is illustrated as a personal digital assistant (PDA), and the client computing device 120C is illustrated as a mobile telephone (e.g., a smartphone). The client computing devices 120A-120C may be located remotely from the server computing device 110. As shown in FIG. 2 with regard to client computing device 120C, the client computing devices 120A-120C also each include an image capturing device 122 (e.g., a camera or scanner), a decode module 126 or application operative to use the image capturing device to read and decode a barcode (e.g., a QR barcode, or the like), and a display 124, and a wireless transceiver 128. The wireless transceiver 128 allows the client computing device 120C to send a request 132 (e.g., a URL) to the server computing device 110 over the network 150, and to receive video content 136 from the server computing device.

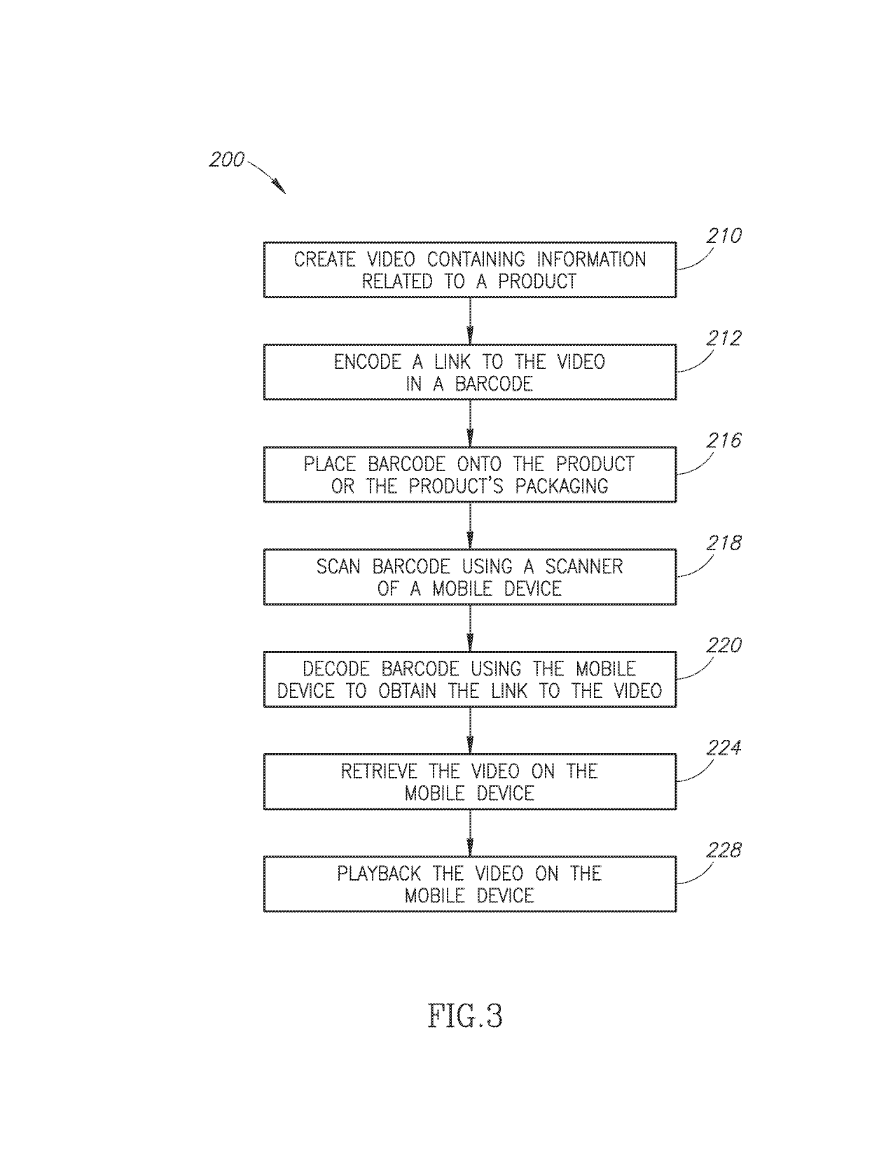

FIG. 3 illustrates a flowchart of a process 200 for using barcodes to provide product information to a user, such as a consumer or a sales associate. Any types of barcodes may be used in the process 200, including QR barcodes, etc. The process 200 begins at block 210, wherein a video containing information relating to a product is created. For example, the video may be an instructional video demonstrating how to use the product, a product safety video, or other video relating to the product. The video may comprise one or more topics, and may be divided into two or more videos that are selectively viewable by a user. In some embodiments, the video may be an existing video or videos stored on the video storage 112 of the server computing device 110 or on a third party storage (e.g., YOUTUBE®, etc.). This step may not always be necessary (e.g., in the case when a video is created by a third party). In some embodiments, the video may be updated or modified periodically, such as when additional or different information is to be provided to a user.

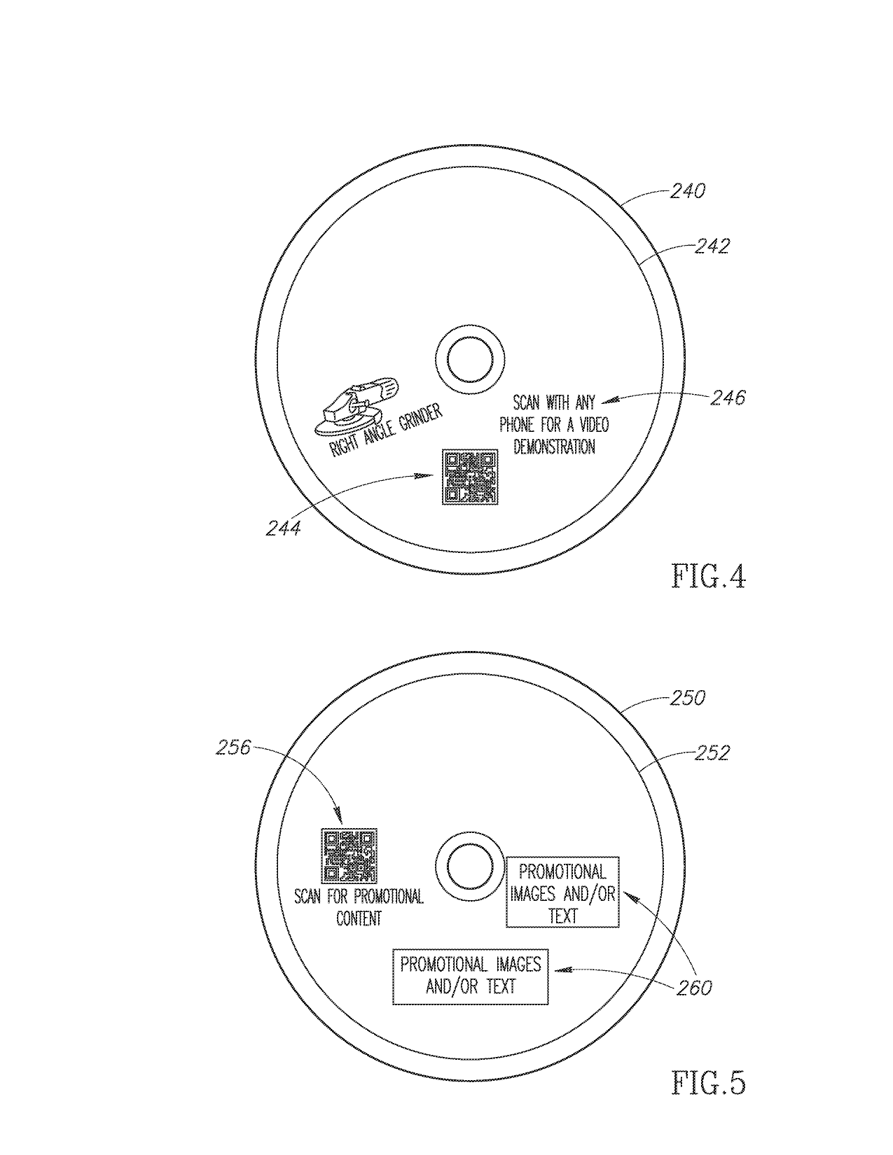

In blocks 212 and 216, a link to the video is encoded into a barcode which is placed on the product or on the product's packaging (see the examples shown in FIGS. 4 and 5). For example, the link may be in the form of a URL or other suitable link operative to allow a user's computing device (e.g., the client computing devices 120A-120C) to access the video over the network 150. In some instances, it is desirable to place the barcode on the product itself, so that users are able to scan the barcode when the product's packaging has been discarded or is otherwise not readily available. In other embodiments, the barcodes may be placed on the outer packaging for the product so consumers and sales associates may scan the barcodes before the product is actually purchased. As can be appreciated, barcodes may be placed on the product, the product packaging, or both.

Once the barcode is in place, a user may then scan the barcode using a scanner of a mobile device (e.g., the consumer devices 120A-120C shown in FIG. 1), block 218. The user may scan the barcode at various times, including: prior to purchasing the product, subsequent to purchasing the product, during use of the product, and the like. The user's mobile device will then decode (e.g., using the decode module 126 shown in FIG. 2) the barcode to obtain the link to the video, send a request 132 for the video, retrieve the video (e.g., using a web browser), and play back the video on the device, blocks 220, 224, and 228. Thus, using this method, a user is easily able to use their mobile device to view one or more videos relating to the product, which may help the user operate the product in a proper and safe manner.

FIG. 4 illustrates an exemplary product on which a label 242 comprising a QR barcode 244 has been placed. In this example, the product comprises an abrasive disc 240 that may be used with a conventional disc grinder (not shown). The label 242 may also include textual or visual instructions 246 directing the user to scan the barcode 244 with the user's camera phone to view a video demonstration using the system 100 described above.

The operation and functionality of abrasive discs may be confusing to many end-users and sales associates because so many abrasive discs look alike but can perform differently based on specific applications. As an example, one product may perform well on stainless steel and look identical to another product that would perform poorly on stainless steel. In this example, the QR barcode 244 may be specific to the abrasive disc 240. That is, each type of abrasive disc may include a barcode 244 that links to a video appropriate for its type so a user will know how to use a specific type of disc. Another issue with abrasive discs is safety. Improper use of the product may lead to safety issues and performance issues. By providing users with easy access to a video that demonstrates proper use of the abrasive disc 240, users are more likely to receive the instructions for using the product and to operate the product more efficiently and safely. It will be appreciated that the features of the present invention will be advantageous for a variety of other products that would benefit from video instructions that demonstrate proper usage. Such products may include, but are not limited to, tools, sporting goods, medical devices, or the like.

FIG. 5 illustrates another embodiment of the present invention. In this embodiment, a QR barcode 256 is included on a label 252 that is affixed to an abrasive disc 250 (or other product). The label also includes promotional images or text 260. As discussed above, other types of barcodes or machine-readable representations of data may also be used. In this embodiment, the QR barcode 256 encodes a link to a video that includes entertainment content and/or advertising content relating to the promotional images or text 260 in addition to or instead of product information. In some embodiments, the promotional images or text 260 and the linked to video may be associated with an advertiser that targets the users of the particular product on which the QR barcode 256 is placed.

In the example shown in FIG. 5, the promotional images and text section 260 of the abrasive disc 250 may include a graphic for the National Association for Stock Car Auto Racing (NASCAR). As an example, the promotional text/images 260 on the label 252 may include one or more photos of a race car, a race car driver, or the like. The QR barcode 256 may link to a video that shows highlights footage of racing events for one or more race car drivers displayed on the label 252. Additionally, the video may include one or more advertisements embedded therein (e.g., an advertisement video that is played for the first 15 seconds of the entertainment video). In this regard, users of the abrasive disc 252 may be able to view an entertaining video, while NASCAR benefits by the user viewing its advertisement. The entertaining and/or advertising videos may be displayed in addition to or instead of an instructional video. It should be appreciated that this example is provided for illustrative purposes, and other products and entities may utilize the QR barcode 256 or other types of barcodes in a similar manner without departing from the scope of the present invention.

### Computing System

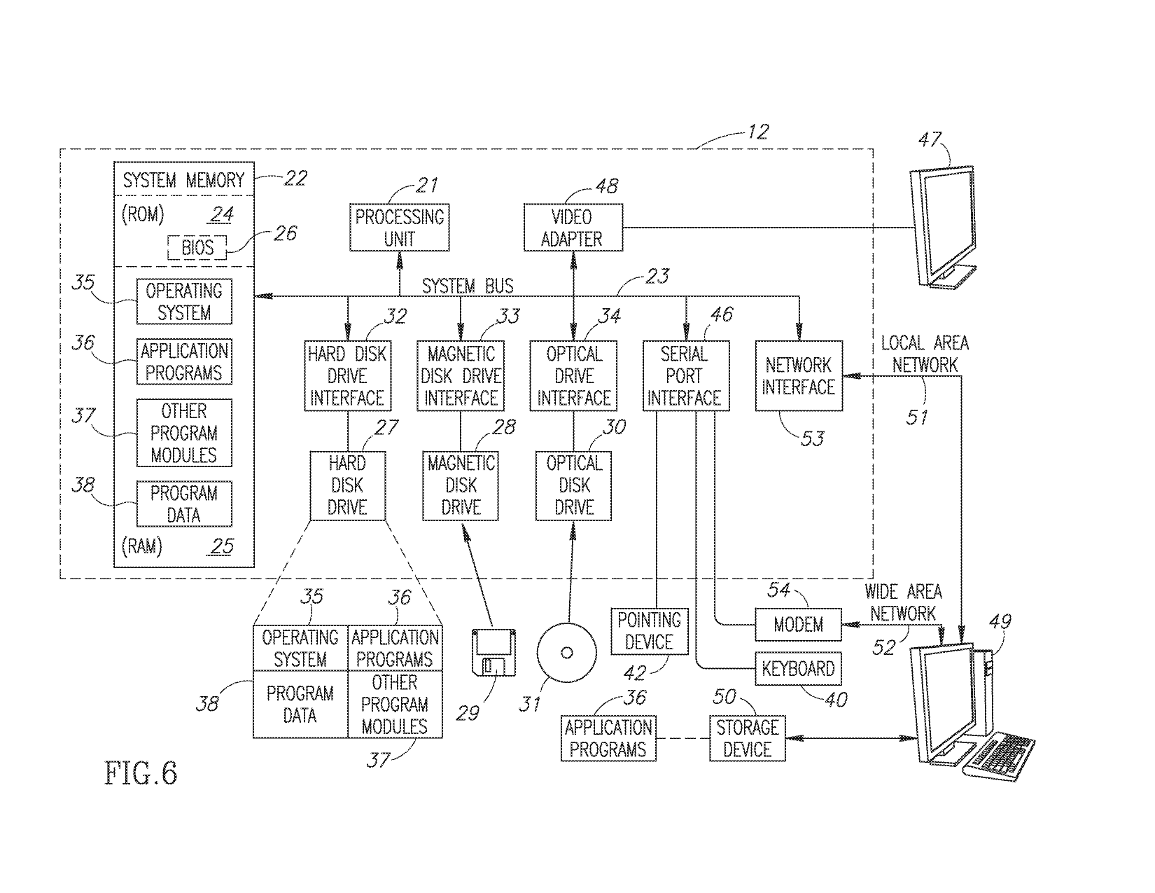

FIG. 6 is a diagram of hardware and an operating environment in conjunction with which implementations of the system 100 may be practiced. The description of FIG. 6 is intended to provide a brief, general description of suitable computer hardware and a suitable computing environment in which implementations may be practiced. Although not required, implementations are described in the general context of computer-executable instructions, such as program modules, being executed by a computer, such as a personal computer or the like. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, cloud computing architectures, and the like. Implementations may also be practiced in distributed computing environments where tasks are performed by remote processing devices that are linked through one or more communications networks. In a distributed computing environment, program modules may be located in both local and remote memory storage devices.

The exemplary hardware and operating environment of FIG. 6 includes a general-purpose computing device in the form of a computing device 12. The computing device 12 includes the system memory 22, a processing unit 21, and a system bus 23 that operatively couples various system components, including the system memory 22, to the processing unit 21. There may be only one or there may be more than one processing unit 21, such that the processor of computing device 12 comprises a single central-processing unit (CPU), or a plurality of processing units, commonly referred to as a parallel processing environment. The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and may include read only memory (ROM) 24 and random access memory (RAM) 25. A basic input/output system (BIOS) 26, containing the basic routines that help to transfer information between elements within the computing device 12, such as during start-up, may be stored in ROM 24. The computing device 12 may further include a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media. The computing device 12 may also include one or more other types of memory devices (e.g., flash memory storage devices, and the like).

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those skilled in the art that any type of computer-readable media which can store data that is accessible by a computer, such as magnetic cassettes, flash memory cards, USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, USB drives, and the like) accessible by the processing unit 21 may be considered components of the system memory 22. Further, “non-transitory” computer-readable media comprises all computer-readable media, with the sole exception being a transitory, propagating signal.

A number of program modules may be stored on the hard disk drive 27, magnetic disk 29, optical disk 31, ROM 24, or RAM 25, including an operating system 35, one or more application programs 36, other program modules 37 (e.g., one or more of the modules and applications described above), and program data 38. A user may enter commands and information into the computing device 12 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus 23, but may be connected by other interfaces, such as a parallel port, game port, a universal serial bus (USB), or the like. A monitor 47 or other type of display device is also connected to the system bus 23 via an interface, such as a video adapter 48. In addition to the monitor, computers typically include other peripheral output devices (not shown), such as speakers and printers.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 6 include a local-area network (LAN) 51 and a wide-area network (WAN) 52. Such networking environments are commonplace in offices, enterprise-wide computer networks, intranets and the Internet.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

The invention claimed is:

1. A system for using barcodes to provide instructional information to a user of a consumer product, comprising:
a video server computing device operatively coupled to a network, the video server computing device being operative to store a video that includes product usage information content and to deliver the video to a client computing device of the user over the network; and
a barcode that is positioned on the consumer product or packaging of the consumer product, the barcode encoding a link to the video;
wherein, when a barcode scanner of the client computing device scans the barcode, the video server delivers the video to the client computing device over the network for viewing by the user on a display of the client computing device.

2. The system of claim 1, wherein the barcode comprises a quick response barcode.

3. The system of claim 1, wherein the barcode encodes a uniform resource locator for the video.

4. The system of claim 1, wherein the video further comprises product safety information or product features information for the consumer product.

5. The system of claim 1, further comprising visual promotional content affixed to the consumer product or packaging of the consumer product proximate to the barcode, wherein the video comprises content relating to the visual promotional content.

6. The system of claim 5, wherein the content relating to the visual promotional content comprises advertising content.

7. The system of claim 1, wherein the video server computing device is configured store a plurality of unique instructional videos relating to a corresponding plurality of unique types of consumer products, and to deliver the plurality of instructional videos to the client computing device over the network, the system further comprising a plurality of unique barcodes each positioned on a corresponding unique type of consumer product or packaging of the consumer product, each of the barcodes encoding a unique link to one of the plurality of videos.

8. An apparatus, comprising:
a consumer product; and
a barcode that is positioned on the body of the consumer product or packaging of the consumer product, the barcode encoding a link to an instructional video accessible over a network, wherein, when a barcode scanner of a client computing device scans the barcode, the video is delivered to the client computing device over the network for viewing on a display of the client computing device.

9. The apparatus of claim 8, wherein the consumer product comprises an abrasive disc.

10. The apparatus of claim 8, wherein the consumer product comprises a tool.

11. The apparatus of claim 8, wherein the barcode encodes a link to an instructional video that is unique for the particular type of the consumer product.

12. The apparatus of claim 8, further comprising visual promotional content affixed to the body of the consumer product or to the packaging of the consumer product, wherein the barcode further encodes a link to video content relating to the visual promotional content.

13. The apparatus of claim 12, wherein the video content relating to the visual promotional content comprises at least one of entertainment content and advertising content.

14. A computer-implemented method of using barcodes to provide video information to a user of a product, the method comprising:
storing an instructional video for the product on a video storage of a video server computing device;
providing a link for accessing the instructional video over a network;
encoding the link in a barcode positioned on the product or on packaging of the product;
receiving at the video server computing device a request for the instructional video over the network from a user computing device of the user subsequent to the user computing device scanning the barcode;
retrieving the instructional video from the video storage; and
sending the instructional video to the user computing device over the network for viewing by the user on a display of the user computing device.

15. The method of claim 14, further comprising storing a promotional video on the video storage, and sending the promotional video to the user computing device over the network for viewing by the user on the display of the user computing device.

16. The method of claim 14, wherein the link comprises a uniform resource locator.

17. The method of claim 14, wherein the barcode comprises a quick response barcode.

18. A method of using barcodes to provide video information to a user of a product, the method comprising:
creating a plurality of instructional videos for a corresponding plurality of unique products;
storing the instructional videos on a video storage of a video server computing device;
for each instructional video, generating a unique link for accessing the instructional video over a network;
for each link, encoding the link in a unique barcode;
positioning each of the unique barcodes on its associated unique product or on packaging of its associated product;
receiving at the video server computing device one of the links over the network from a user computing device of the user subsequent to the user computing device scanning one of the barcodes;
retrieving the instructional video from the video storage that corresponds to the received link; and
sending the corresponding instructional video to the user computing device over the network for viewing by the user on a display of the user computing device.

19. The method of claim 18, wherein the plurality of products comprise different types of tools.

20. The method of claim 18, wherein the plurality of products comprise different types of abrasive discs.
